(19) United States
(12) Patent Application Publication
(10) Pub. No.: US 2026/0351456 A1
(43) Pub. Date: Nov. 5, 2026

(54) TRANSFORMER ASSEMBLIES AND POWER CONVERTERS

(71) Applicant: Infineon Technologies Austria AG, Villach (AT)

(72) Inventors: Mario URSINO, Villach (AT); Roberto RIZZOLATTI, Villach (AT); Kevin ZUFFERLI, Fagagna (IT)

(21) Appl. No.: 19/197,029

(22) Filed: May 2, 2025

(51) Int. Cl. H01F 27/02; H01F 27/06; H01F 27/28; H01F 27/32; H01F 27/42

(52) U.S. Cl. CPC H01F 27/022; H01F 27/027; H01F 27/06; H01F 27/2847; H01F 27/323; H01F 27/425; H01F 27/065

(57) ABSTRACT

This disclosure includes one or more novel transformer assemblies comprising: a pre-fabricated component and first material. The pre-fabricated component includes: i) a stack of multiple transformer windings, and ii) multiple electrically conductive paths connected to the multiple windings in the stack. The first material is disposed (such as via injection) in voids of the pre-fabricated component. The first material envelops the stack of multiple transformer windings to provide magnetic coupling between the multiple transformer windings. Additionally, the injected first material provides structural support to the pre-fabricated component and electrically conductive paths disposed in the transformer assembly.

### BACKGROUND

A conventional printed circuit board (PCB) or printed wiring board is a laminated structure of conductive layers separated by insulating layers. In general, PCBs have two functions. The first is to secure electronic components at designated locations on the outer layers by means of soldering. The electronic circuit instantiated by the populated circuit board is designed to provide one or more specific functions. After fabrication, the electronic circuit is powered to perform the desired functions.

Typically, a printed circuit board is a planar device on which multiple components are interconnected via traces to provide the functions as previously discussed. Such implementations of fabricating circuitry on a planar circuit board assembly is dimensionally limited.

Typically power converter designs today utilize VRD circuits from a 12 volt mid voltage from the 48 volts with multiphase circuits to mount to the motherboard/substrate. These present solutions provide a solution from the 12 volt intermediate rail with higher density and efficiency, but these solutions are driven from a combination of a 48 volt input rail to a 12 volt rail and 12 volt to core with a VR module with both losses summed for the total loss.

The conventional 48V to core power converter solutions today are mounted laterally to power the processor and the lateral losses are high as you provide power from the motherboard to the processor core substrate to power the processor since the PDN circuit has extra trace resistance that is higher. The lateral support of power also has much higher inductance in series with the processor which causes higher transients for the processor due to the high di/dt of the current transients that must pass through this series inductance. Efficiency is lower and transient is worsened due to series resistance and inductance. A 48 volt converter to core today is connected laterally with lossy series connection. Higher density is not achieved and transient currents require more capacitance to meet the specification due to the higher series inductance to the load.

### BRIEF DESCRIPTION

Implementation of clean energy (or green technology) is very important to reduce our impact as humans on the environment. In general, clean energy includes any evolving methods and materials to reduce an overall toxicity of energy consumption to the environment.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, etc. Regardless of whether energy is received from green energy sources or non-green energy sources, it is desirable to make most efficient use of raw energy provided by such systems to reduce our impact on the environment. This disclosure contributes to reducing our carbon footprint (and green energy) via more efficient energy conversion and circuit implementations supporting same.

As discussed herein, a fabricator produces a novel transformer assembly via a pre-fabricated component and first material. The pre-fabricated component includes: i) a stack of multiple transformer windings, and ii) connectivity of the multiple windings in the stack to electrically conductive paths. The first material may be disposed (such as via injection or other technique) in voids of the pre-fabricated component. The injected first material can be configured to envelop the stack of multiple transformer windings to provide magnetic coupling between the multiple transformer windings. Additionally, advantageously, the injected first material provides (physical) structural support to the pre-fabricated component disposed in the transformer assembly.

In one example, via a fabricator, the first material is injected into the voids of the pre-fabricated component subsequent to directly coupling the multiple transformer windings in the stack to the multiple electrically conductive paths. The first material injected into the voids of the pre-fabricated component may include magnetically permeable material. In such an instance, the magnetically permeable material provides the magnetic coupling between the multiple transformer windings. It is further noted that the injected first material provides structural support retaining the stack of multiple transformer windings and/or the multiple electrically conductive paths together.

If desired, the transformer assembly can be configured to include second material such as insulator material that at least partially envelops the injected first magnetically permeable material. The second material may be injected into the transformer assembly to provide further structural support associated with the multiple transformer windings and/or the multiple electrically conductive paths.

In yet a further example, as previously discussed, the first material may be injected into the voids of the pre-fabricated component. In such an instance, after curing, or solidifying, the injected first material may be a monolithic mass of magnetically permeable material structurally supporting physical connections of the electrically conductive paths to the multiple transformer windings.

Still further, the multiple electrically conductive paths of the transformer assembly may be at least partially embedded in the first material. The transformer assembly may further include at least one peripheral surface (such as one or more site surfaces) where one or more of the multiple electrically conductive paths is disposed on the at least one peripheral surface.

According to a further example, the transformer assembly may include a top surface and a bottom surface. A first electrically conductive path of the multiple electrically conductive paths can be configured to extend to the top surface. A second electrically conductive path of the multiple electrically conductive paths can be configured to extend to the bottom surface. Further, if desired, the first electrically conductive path can be configured to extend axially from the bottom surface to the top surface; the second electrically conductive path can be configured to extend axially from the bottom surface to the top surface as well, where the second electrically conductive path is disposed in parallel with the first electrically conductive path.

In another example, the transformer assembly includes a top surface and a bottom surface. The transformer assembly further includes a first surface mount footprint disposed on the top surface and a second surface mount footprint disposed on the bottom surface. If desired, a pattern of the first surface mount footprint may be substantially similar to a pattern of the second surface mount footprint.

As further discussed herein, the transformer assembly can be configured to include at least a first side surface disposed between the top surface and a bottom surface of the transformer assembly. The multiple electrically conductive paths may be partially or fully embedded in the first material enveloping the pre-fabricated component. In such an instance, the first material injected into the voids and openings of the pre-fabricated component provides structural support for the connectivity between the multiple electrically conductive paths in the multiple windings.

In one example, the transformer assembly includes a first electrically conductive path exposed on the first side surface. If desired, the first electrically conductive path can be configured to extend on the first side surface between the top surface of the transformer assembly and the bottom surface of the transformer assembly. Alternatively, the first electrically conductive path may extend only partially between the top surface and the bottom surface.

Still further examples as discussed herein include implementing the transformer assembly to include physical interconnectivity of the multiple electrically conductive paths such that the stack of multiple transformer windings is an autotransformer.

In yet another example as discussed herein, the multiple transformer windings in the windings stack may include: a first transformer winding fabricated in a first plane and a second transformer winding fabricated in a second plane, the first plane parallel with respect to the second plane. The multiple electrically conductive paths can be configured to extend orthogonally in the transformer assembly with respect to the first plane and the second plane. The pre-fabricated component can be configured to include multiple insulation layers such as at least a first layer of insulation material separating the first transformer winding and the second transformer winding.

In another example, the first material disposed in the voids of the pre-fabricated component includes ferromagnetic material operative to convey magnetic flux associated with the multiple transformer windings.

Another example as discussed herein includes a circuit assembly comprising the transformer assembly as previously discussed. The transformer assembly can be configured to include a top surface and a bottom surface. The circuit assembly may further include a first circuit substrate and a second circuit substrate, where the first circuit substrate is affixed to the top surface of the transformer assembly and the second circuit substrate is affixed to the bottom surface of the transformer assembly.

In further examples, the circuit assembly can be configured to include: a first electrically conductive path extending from the second circuit substrate to the first circuit substrate, where the first electrically conductive path is operative to convey an input voltage through the first electrically conductive path to the first circuit substrate; and a second electrically conductive path extending from the top surface of the transformer assembly to a first winding of the multiple windings. The circuit assembly may further include switch circuitry disposed on the first circuit substrate, where the switch circuitry is operative to control conveyance of current received from the input voltage through the second electrically conductive path to the first winding.

In the further examples herein include one or more method of fabricating a transformer assembly. The method may include a fabricator: receiving a pre-fabricated component including voids and/or openings, the pre-fabricated component comprising: i) a stack of multiple transformer windings, and ii) multiple electrically conductive paths connected to the multiple windings in the stack; and disposing first material in the voids of the pre-fabricated component, the injected first material enveloping the stack of multiple transformer windings to provide magnetic coupling between the multiple transformer windings.

Note that any of the resources as discussed herein can include one or more computerized devices, apparatus, hardware, etc., execute and/or support any or all of the method operations disclosed herein. In other words, one or more computerized devices or processors can be programmed and/or configured to operate as explained herein to carry out the different techniques as described herein.

Other aspects of the present disclosure include software programs and/or respective hardware to perform any of the operations summarized above and disclosed in detail below.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of techniques herein (BRIEF DESCRIPTION) purposefully does not specify every novel aspect of the present disclosure or claimed invention(s). Instead, this brief description only presents general aspects and corresponding points of novelty over conventional techniques. For additional details and/or possible perspectives (permutations) of the invention(s), the reader is directed to the Detailed Description section (which is a summary) and corresponding figures of the present disclosure as further discussed below.

### BRIEF DESCRIPTION OF THE DRAWINGS

FIG. 1 is an example diagram illustrating a transformer assembly as discussed herein.

FIG. 2 is an example 3-dimensional diagram illustrating fabrication of a stack of multiple transformer windings and connectivity of those multiple transformer windings to electrically conductive paths to form a pre-fabricated component as discussed herein.

FIG. 3 is an example 3-dimensional diagram illustrating fabrication of a transformer assembly as discussed herein.

FIG. 4A is an example 3-dimensional diagram illustrating a cutaway view of a transformer assembly as discussed herein.

FIG. 4B is an example side view diagram illustrating a cutaway view of a transformer assembly as discussed herein.

FIG. 5A is an example 3-dimensional diagram illustrating a cutaway view of a transformer assembly as discussed herein.

FIG. 5B is an example side view diagram illustrating a cutaway view of a transformer assembly as discussed herein.

FIG. 6A is an example 3-dimensional diagram illustrating a cutaway view of a transformer assembly as discussed herein.

FIG. 6B is an example top view diagram illustrating a cutaway view of a transformer assembly as discussed herein.

FIG. 7 is an example 3-dimensional exploded view of a circuit assembly as discussed herein.

FIG. 8 is an example side view diagram of the circuit assembly as discussed herein.

FIG. 9 is an example diagram illustrating a power converter circuit implementing a transformer assembly to convert an input voltage into an output voltage as discussed herein.

FIG. 10 is an example timing diagram illustrating control states of the multiple switches in the power converter circuit of FIG. 9 as discussed herein.

FIG. 11 is an example method of fabricating a transformer assembly as discussed herein.

The foregoing and other objects, features, and advantages of the disclosed matter herein will be apparent from the following more particular description herein, as illustrated in the accompanying drawings in which like reference characters refer to the same parts throughout the different views. The drawings are not necessarily to scale, with emphasis instead being placed upon illustrating the principles, concepts, aspects, techniques, etc.

### DETAILED DESCRIPTION

A novel transformer assembly as discussed herein includes a combination of a pre-fabricated component and at least first material. The pre-fabricated component includes: i) a stack of multiple transformer windings, and ii) multiple electrically conductive paths connected to the multiple transformer windings in the stack. First material is disposed (such as via injection or other suitable technique) in voids of the pre-fabricated component. The first material envelops the stack of multiple transformer windings to provide magnetic coupling between the multiple transformer windings. Additionally, the first material (when cured or after solidification) may also provide structural support to the stack of multiple transformer windings and the multiple electrically conductive paths in the pre-fabricated component. If desired, second material may be injected to envelop the injected first material. The presence of the second material enveloping the first material may provide protection to the first material encapsulating the prefabricated component (stack of transformer windings).

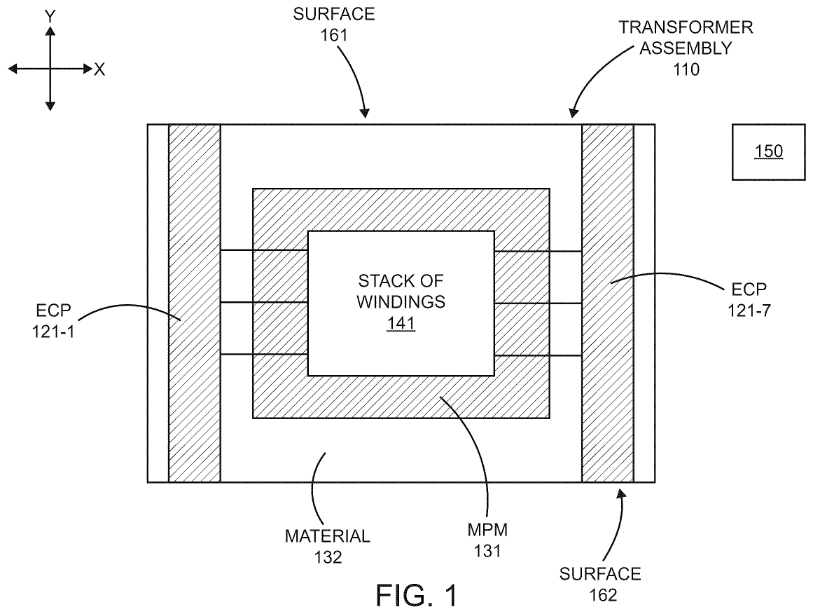

Now, more specifically, FIG. 1 is an example diagram illustrating a transformer assembly for inclusion in a power converter or other type of circuit as discussed herein.

In this example, the fabricator 150 produces the transformer assembly 110 to include multiple elements or circuit components such as stack 141 of multiple transformer windings, vertically oriented electrically conductive paths 121 (such as electrically conductive path 121-1, 121-7, etc.), and filler or structural material such as one or more of first magnetically permeable material 131, second material 132, etc., providing structural support of retaining the components in an appropriate orientation with respect to each other.

As previously discussed, the electrically conductive paths 121 may include electrically conductive path 121-1, electrically conductive path 121-7, etc. The electrically conductive paths can be fabricated using any suitable electrically conductive material such as metal or metal alloy supporting conveyance of current over a low impedance/resistive path.

It is noted that each of the electrically conductive paths 121 can be configured to extend between the bottom surface 161 of the transformer assembly 110 to the top surface 162 of the transformer assembly 110.

Alternatively, note that the vertically oriented electrically conductive paths disposed in the transformer assembly 110 may extend only from one surface (such as surface 161, surface 162, etc.) of the transformer assembly 110 to a mid-section of the transformer assembly 110 without extending to the opposite surface.

In a further example, the material 132 may be the same magnetic permeable material such as magnetically permeable material 131. Alternatively, the material 132 encapsulating the magnetically permeable material 131 may be epoxy or other suitable material providing encapsulation about the material 131 and may provide further structural support associated with the components in the transformer assembly 110. Thus, structural support associated with the transformer assembly 110 may be provided by one or more of material 131, material 132, etc.

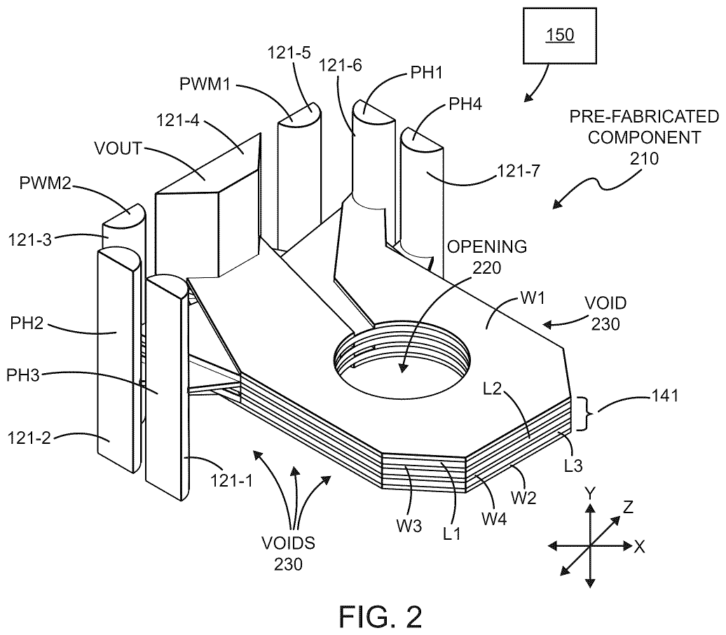

Note further that the transformer assembly 110 can be fabricated in any suitable manner. In one example, a combination of the internal elements associated with the transformer assembly 110 such as the electrically conductive paths 121 and the stack 141 of transformer windings may be connected to each other to produce a pre-fabricated component (210) prior to the fabricator 150 disposing the magnetically permeable material in corresponding voids and openings of the prefabricated component. Additional details of the prefabricated component from which the transformer assembly 110 is fabricated is shown in FIG. 2.

Accordingly, with further reference to FIG. 1, the magnetically permeable material 131 (such as including ferromagnetic material) and/or second material 132 (such as insulative material or not electrically conductive material) in the transformer assembly 110 can be configured to structurally prevent movement of the internal elements (such as electrically conductive paths 121, stack of transformer windings 141, respective connectivity, etc.) of the transformer assembly.

Accordingly, the magnetically permeable material 131 can be a mesh or mold of one or more material such as magnetically permeable material 131, material 132, etc., that holds the whole mechanical assembly of elements together.

In another example, the one or more elements such as the electrically conductive paths 121, stack of multiple transformer windings 141, etc., associated with the transformer assembly may be embedded or at least partially embedded into the transformer assembly 110. Certain portions of the electrically conductive paths 121 may be disposed/exposed on the top surface 162, bottom surface 161, and any of the side surfaces of the transformer assembly 110. In

As previously discussed, the stack 141 can be configured to include insulation material or insulator material (non-electrically conductive material) separating each of the windings in the stack 141. The presence of the insulator material between the windings of the stack 141 prevents the magnetically permeable material 131 or insulation material 132 from being injected into the spacings between each of the windings in the stack 141. This is discussed in more detail in the following drawings.

FIG. 2 is an example 3-dimensional diagram illustrating fabrication of a stack of multiple transformer windings and connectivity of multiple transformer windings to electrically conductive paths as discussed herein.

In one example, the fabricator 150 or other suitable entity produces the pre-fabricated component 210 as shown in FIG. 2. In this example, the pre-fabricated component 210 includes: i) a stack 141 of multiple transformer windings, and ii) multiple electrically conductive paths 121 connected to the multiple windings in the stack 141.

As further shown in FIG. 2, the pre-fabricated component 210 can be configured to include multiple windings disposed in the stack 141. More specifically, the transformer windings in the stack 141 may include: a first transformer winding W1 substantially fabricated in a first plane (such as a plane parallel to the X-Z plane), a second transformer winding W3 fabricated in a second plane (such as a first plane parallel to the X-Z plane), a third transformer winding W4 fabricated in a third plane (such as a first plane parallel to the X-Z plane), and so on.

Accordingly, the first plane in which the first winding W1 resides in parallel with respect to the second plane in which the second winding W3 resides, and so on.

As previously discussed, the stack 141 in the pre-fabricated component 210 further includes an insulation layer between each of the different windings of the stack 141. For example, the stack 141 of windings includes the insulation layer L1 disposed between the first winding W1 and the second winding W3. The insulation layer L1 is any suitable non-electrically conductive material. Accordingly, the insulation layer L1 provides separation between the first transformer winding W1 and the second transformer winding the W3.

Yet further, it is notable that the multiple electrically conductive paths 121 can be configured to extend orthogonally in the pre-fabricated component 210 with respect to the first plane and the second plane.

More specifically, each of the electrically conductive paths 121 can be configured to extend axially alongside (parallel to) the Y-axis. For example, as shown in FIG. 2, the electrically conductive path 121-1 extends along or parallel to the Y-axis, which is orthogonal to the X-Z plane and corresponding transformer windings.

Still further, it is noted that each of the multiple windings in the stack 141 is electrically connected to multiple electrically conductive paths in the pre-fabricated component 210. For example winding W1 is connected between the electrically conductive path 121-6 in the electrically conductive path 121-4; the winding W3 is connected between the electrically conductive path 121-2 and the electrically conductive path 121-4; and so on.

Additional details of the connectivity associated with the pre-fabricated component 210 is further discussed below.

It is further noted that the pre-fabricated component 210 includes the opening 220 through each of the windings in the stack 141. The opening 220 may be occupied by air. The pre-fabricated component 210 further includes voids 230 (such as initially open to air) about the stack 141 of windings.

Further fabrication of the transformer assembly 110 is discussed herein provides magnetic coupling amongst the windings in the stack 141.

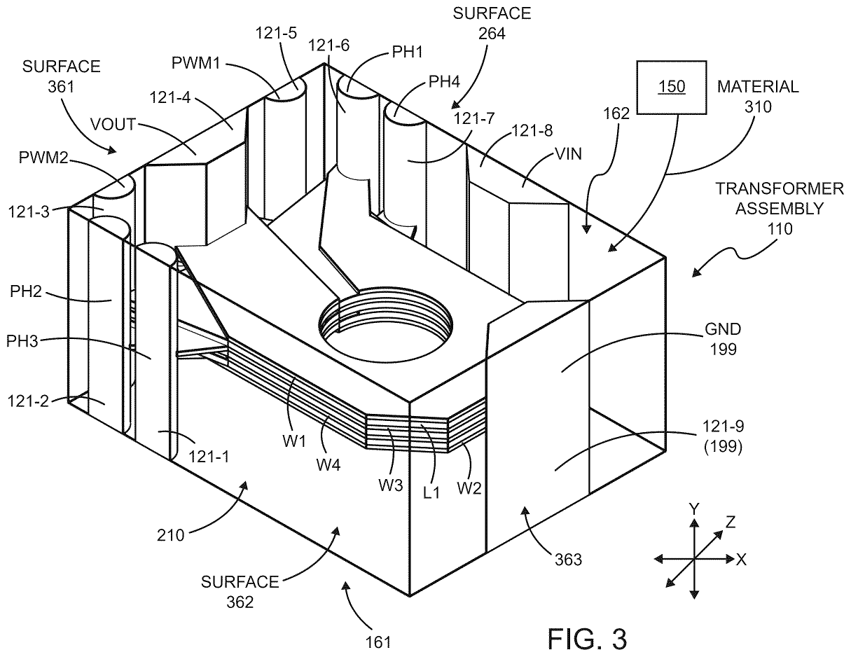

FIG. 3 is an example 3-dimensional diagram illustrating fabrication of a transformer assembly as discussed herein.

Further in this example, the fabricator 150 receives the pre-fabricated component 210 and encapsulates at least the stack 141 of multiple windings and fills in the voids 230 and corresponding opening 220 with material 310 (one or more materials).

In one example the fabricator 150 injects first flowable material (such as material 310) into the voids 230 of the pre-fabricated component 210 subsequent to directly coupling the multiple electrically conductive paths 121 to the multiple transformer windings in the stack 141.

Alternatively, it is noted that the fabricator 150 or other suitable entity can be configured to encapsulate the windings in the stack 141 prior to providing connectivity of the windings to the respective electrically conductive paths 121 in disposed on the outer periphery of or embedded in the transformer assembly 110.

The material 310 may be injected to envelop (surround) the stack of windings 141 as well as fill the opening 220, where the material 310 is magnetically permeable material operative to provide magnetic coupling between the multiple transformer windings in the stack 141.

Accordingly, the fabricator 150 can be configured to inject to the material 310 such as a flowable solid and/or liquid material into the voids 230 and the opening 220.

Eventually, the injected flowable solid-liquid material turns into a solid material, such that the material 310 provides structural support retention (holding in place) the stack of multiple transformer windings with respect to the multiple electrically conductive path. In such an instance, the connectivity of the multiple windings in the stack 141 to the electrically conductive paths 121 provides initial structural support. Additionally, the injection or disposing of the material 310 in the voids 230 and the opening 220 of the pre-fabricated component 210 provides yet further structural support for the final transformer assembly 110.

If desired, the injection of the material 310 into the voids and opening of the pre-fabricated component 210 may be a multi-process step in which the fabricator 150 first injects first magnetically permeable material to fill the opening 221 and fill the voids 232 to encapsulate the stack 141. The fabricator 150 can be configured to further inject second material 132 about the injected first material to produce the transformer assembly 110 as shown in FIG. 3. The second material may at least partially envelop the injected first material 131 in the transformer assembly 110.

Alternatively, the transformer assembly 110 is fabricated via injection of a single magnetically permeable material 310 to occupy the voids 230 and the opening 220.

Accordingly, the transformer assembly 110 can be configured to include one or more materials providing structural support. In one example, after solidifying, the injected material 310 is or becomes a monolithic mass of magnetically permeable material structurally supporting physical connection of the electrically conductive paths 121 to the multiple transformer windings in the stack 141.

Still further, it is noted that the multiple electrically conductive paths 121 may be at least partially or fully embedded in the material 310, where the electrically conductive paths 121 potentially extend between the top surface 162 to the bottom surface 161 of the transformer assembly 110. Further, the electrically conductive paths may extend only partially between one surface 161 and another surface 162 of the transformer assembly 110.

As previously discussed, one or more of the electrically conductive paths 121 may include a respective surface that is exposed with respect to the transformer assembly 110. More specifically, the transformer assembly 110 can be configured to include peripheral surfaces 361, 362, 363, etc. At least a portion of the electrically conductive path 121-1 may be exposed on the surface 362; at least a portion of the electrically conductive path 121-2 may be exposed on the surface 362; at least a portion of the electrically conductive path 121-3 may be exposed on the surface 361; at least a portion of the electrically conductive path 121-4 may be exposed on the surface 361; at least a portion of the electrically conductive path 121-5 is exposed on the surface 361; at least a portion of the electrically conductive path 121-6 may be exposed on the surface 364; at least a portion of the electrically conductive path 121-7 may be exposed on the surface 364; at least a portion of the electrically conductive path 121-8 may be exposed on the surface 364; at least a portion of the electrically conductive path 121-9 b expose on the surface 363; and so on.

If desired, one or more or all of the multiple electrically conductive paths can be configured to extend between the bottom service 161 to the top surface 162, where the axial ends of the electrically conductive paths are exposed for soldering.

For example, a first axial end of the electrically conductive path 121-1 is exposed on the bottom surface 161; a second axial end of the electrically conductive path 121-1 is exposed on the top surface 162. In this example, the electrically conductive path 121-1 represents the node PH3.

A first axial end of the electrically conductive path 121-2 (a.k.a., node PH2) is exposed on the bottom surface 161; a second axial end of the electrically conductive path 121-2 is exposed on the top surface 162. The electrically conductive path 121-2 represents the node PH2.

A first axial end of the electrically conductive path 121-3 is exposed on the bottom surface 161; a second axial end of the electrically conductive path 121-3 is exposed on the top surface 162. The electrically conductive path 121-3 is configured to carry the signal PWM2 (a.k.a., control signal S2).

A first axial end of the electrically conductive path 121-4 is exposed on the bottom surface 161; a second axial end of the electrically conductive path 121-4 is exposed on the top surface 162. The electrically conductive path 121-4 is configured to convey the signal Vout.

A first axial end of the electrically conductive path 121-5 is exposed on the bottom surface 161; a second axial end of the electrically conductive path 121-5 is exposed on the top surface 162. The electrically conductive path 121-5 is configured to carry the signal PWM1 (a.k.a., control signal S1).

A first axial end of the electrically conductive path 121-6 is exposed on the bottom surface 161; a second axial end of the electrically conductive path 121-6 is exposed on the top surface 162. The electrically conductive path 121-6 represents the node PH1.

A first axial end of the electrically conductive path 121-7 is exposed on the bottom surface 161; a second axial end of the electrically conductive path 121-7 is exposed on the top surface 162. The electrically conductive path 121-7 represents the node PH4.

A first axial end of the electrically conductive path 121-8 is exposed on the bottom surface 161; a second axial end of the electrically conductive path 121-8 is exposed on the top surface 162. The electrically conductive path 121-8 conveys the input voltage Vin from the bottom surface 161 to the top surface 162.

A first axial end of the electrically conductive path 121-9 is exposed on the bottom surface 161; a second axial end of the electrically conductive path 121-9 is exposed on the top surface 162. The electrically conductive path 121-9 conveys the ground reference 199. In such an instance, current flows from the top surface 162 through the electrically conductive path 121-9 to the bottom surface 161.

In one example, each of the electrically conductive paths 121 is disposed in parallel with each other and the Y-axis. However, the electrically conductive paths 121 can be configured to extend in any suitable one or more directions.

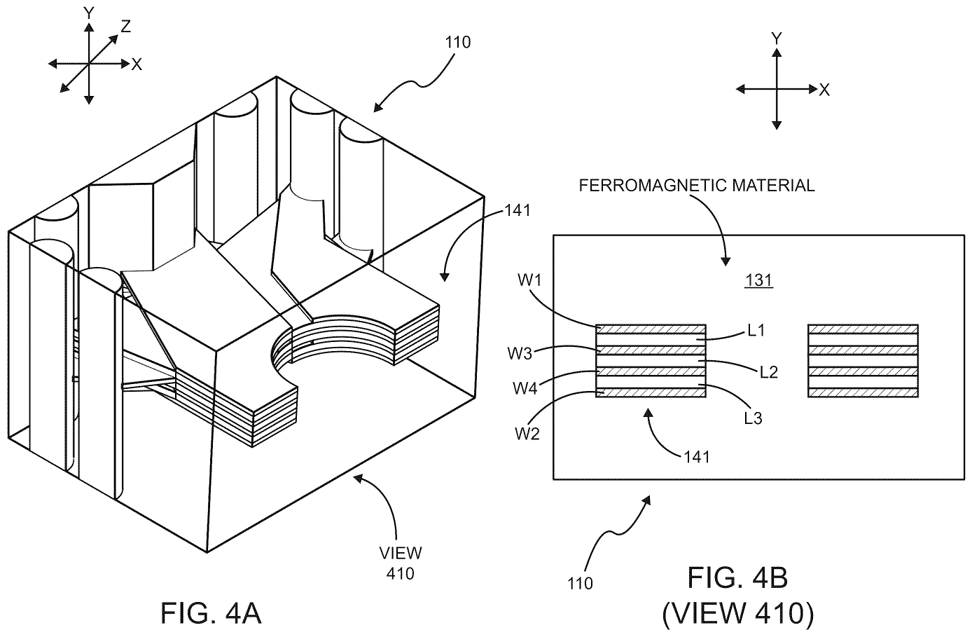

FIG. 4A is an example 3-dimensional diagram illustrating a cutaway view of a transformer assembly as discussed herein.

In this example, the cutaway view of the transformer assembly 110 is along the X-axis as view 410. The view 410 of the cutaway of the transformer assembly 110 along the X-axis is shown in FIG. 4B.

FIG. 4B is an example side view diagram illustrating a cutaway view of a transformer assembly as discussed herein.

As previously discussed, the windings in the stack 141 are separated by respective layers of insulation material.

For example, as shown in view 410 of FIG. 4B the transformer winding W1 is separated from the transformer winding W3 via the insulator layer L1; the transformer winding W3 is separated from the transformer winding W4 via the insulator layer L2; the transformer winding W4 is separated from the winding W2 via the insulator layer L3.

The transformer assembly 110 and corresponding windings in the stack 141 can be configured to include any number of windings and insulation layers.

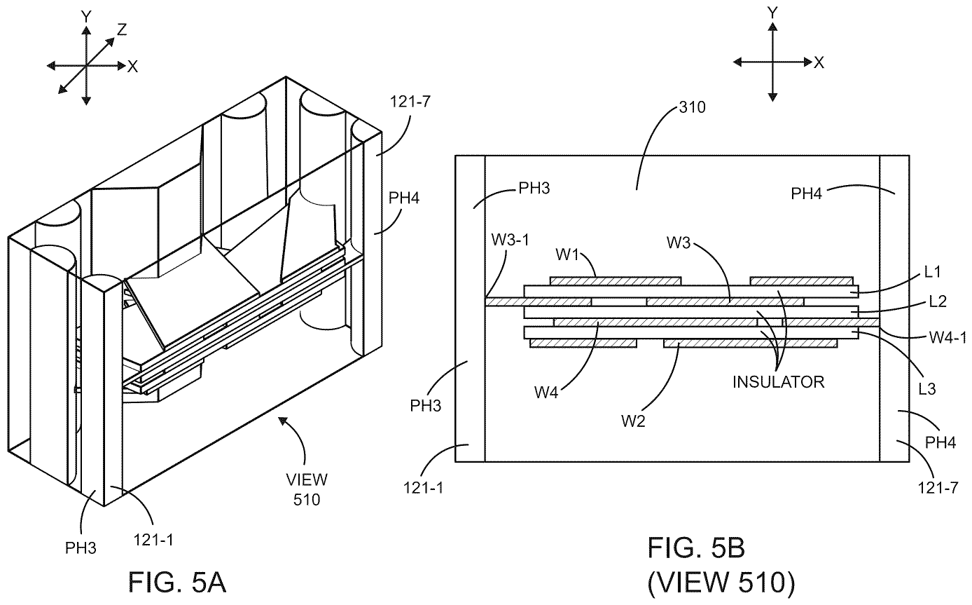

FIG. 5A is an example 3-dimensional diagram illustrating a cutaway view of a transformer assembly as discussed herein.

In this example, the cutaway view of the transformer assembly 110 is along the X-axis as view 510. The view 510 of the cutaway of the transformer assembly 110 along the X-axis is shown in FIG. 5B.

FIG. 5B is an example side view diagram illustrating a cutaway view of a transformer assembly as discussed herein.

As previously discussed, the windings in the stack 141 are separated by respective layers of insulation material.

For example, as shown in view 510 of FIG. 5B the transformer winding W1 is separated from the transformer winding W3 via the insulator layer L1; the transformer winding W3 is separated from the transformer winding W4 via the insulator layer L2; the transformer winding W4 is separated from the winding W2 via the insulator layer L3.

The transformer assembly 110 can be configured to include any number of windings and insulation layers in the stack 141.

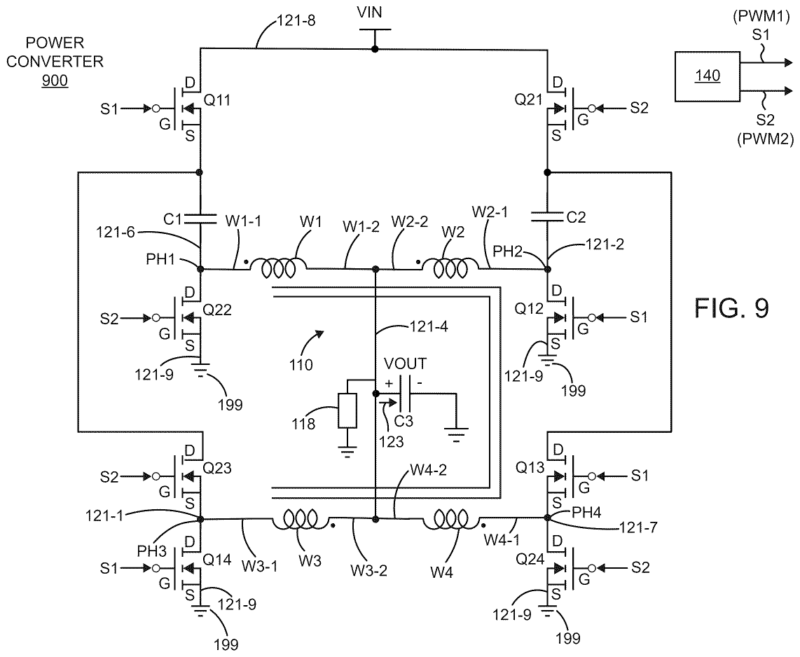

As previously discussed, axial end W3-1 of the winding W3 is directly connected to the electrically conductive path 121-1 (PH3). As further discussed herein in other FIGS., the other axial end W3-2 (see FIG. 9) of the winding W3 is directly connected to the electrically conductive path 121-4.

Axial end W4-1 of the winding W4 is directly connected to the electrically conductive path 121-7. As further discussed herein in other FIGS., the other axial end W4-2 (see FIG. 9) of the winding W4 is directly connected to the electrically conductive path 121-4.

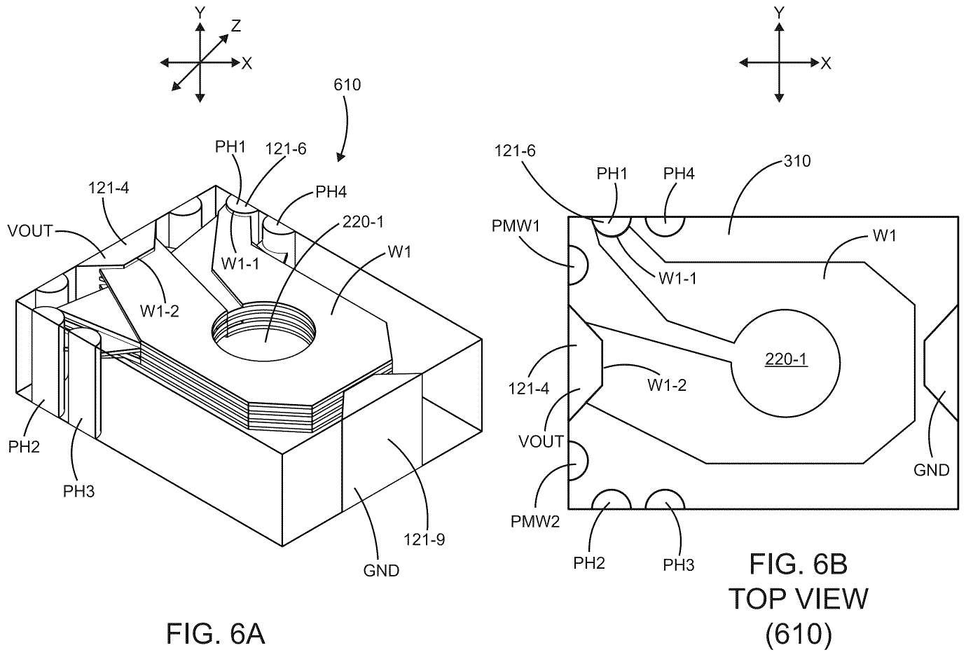

FIG. 6A is an example 3-dimensional diagram illustrating a cutaway view of a transformer assembly as discussed herein.

In this example, the cutaway view of the transformer assembly 110 is along the Y-axis as view 610. The view 610 of the cutaway of the transformer assembly 110 along the Y-axis is shown in FIG. 6B.

FIG. 6B is an example top view diagram illustrating a cutaway view of a transformer assembly as discussed herein.

As shown, and as previously discussed, axial end W1-1 of the winding W1 is directly connected to the electrically conductive path 121-6 in the pre-fabricated component 210 of transformer assembly 110. The other axial end W1-2 of the winding W1 is directly connected to the electrically conductive path 121-4 in the pre-fabricated component 210 of transformer assembly 110.

In a similar manner, each of the windings in the stack 141 includes a first terminal end connected to a first electrically conductive path of the transformer assembly 110 and a second terminal end connected to a second electrically conductive path of the transformer assembly.

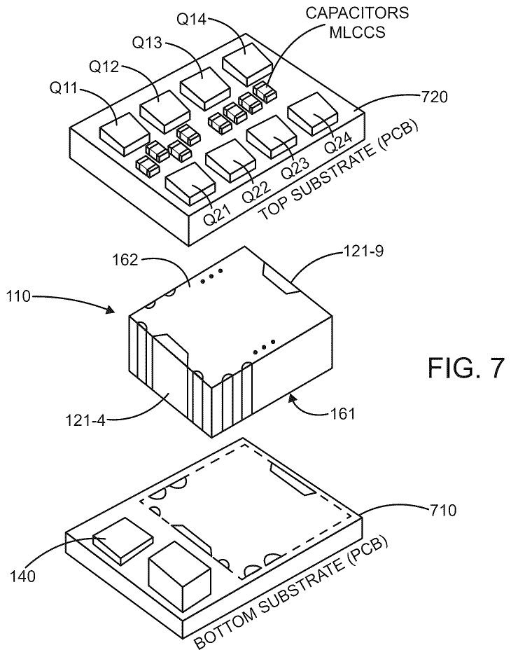

FIG. 7 is an example 3-dimensional exploded view of a circuit assembly as discussed herein.

In this example, the circuit assembly 700 as shown in FIG. 7 includes substrate 710, transformer assembly 110, and substrate 720.

The substrate 710 can be configured to include the controller 140, which produces respective control signals S1 (PWM1) and S2 (PWM2).

The transformer assembly 110 provides multiple windings to convert a respective input voltage Vin supplied by the substrate 710 into the output voltage 123.

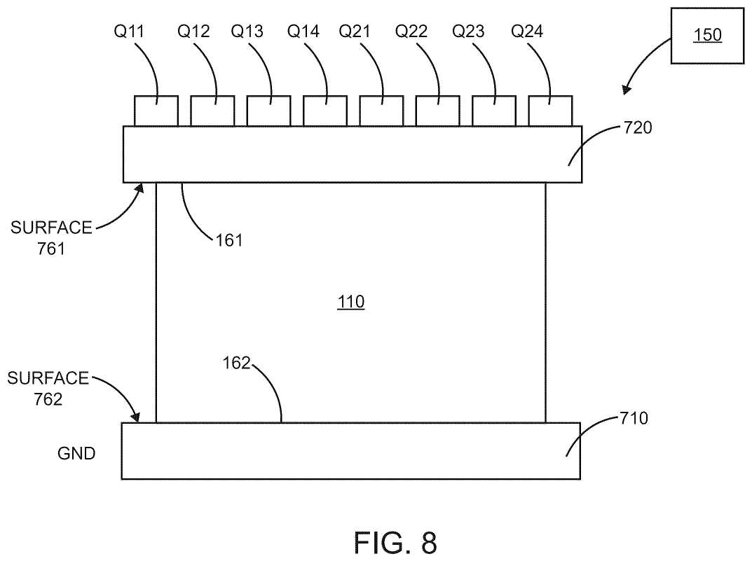

The substrate 720 can be configured to include the switch circuitry (Q11, Q12, Q13, . . . , Q21, Q22, Q23, . . . ) and corresponding capacitors C1, C2, C3, etc. Respective connectivity of the elements shown in FIG. 7 is further discussed in FIGS. 8 and 9.

With further reference to FIG. 7, as previously discussed, the transformer assembly 110 can be configured to include any number of electrically conductive paths 121 extending from the bottom surface 161 to the top surface 162 of the transformer assembly 110.

In another example, the transformer assembly 110 includes a first surface mount footprint associated with the first axial ends of the electrically conductive paths terminating on the surface 162. The transformer assembly 110 further includes a second surface mount footprint associated with the second axial ends of the electrically conductive paths 121 terminating on the surface 161.

The presence of the electrically conductive paths extending between the bottom surface 161 and the top surface 162 provides a good heatsink path of conveying heat from the substrate 710 through the electrically conductive paths 121 to the substrate 720. In an opposite direction, the electrically conductive paths 121 provide a good heatsink path of conveying heat from the substrate 720 through the electrically conductive paths 121 to the substrate 710.

In one example, the surface mount pattern of the first axial ends of the electrically conductive paths 121 on the surface 162 substantially matches or is substantially similar to the surface mount pattern of the second axial ends of the electrically conductive paths 121 disposed on the bottom surface 161. As previously discussed, the electrically conductive paths 121 may be embedded in the side surfaces of the transformer assembly 110. In other words, the multiple electrically conductive paths 121 may be at least partially embedded in the first material 131 enveloping the pre-fabricated component 210. Additionally, one or more of the electrically conductive paths 121 may be exposed on a side surface of the transformer assembly 110.

FIG. 8 is an example side view diagram of the circuit assembly as discussed herein.

In this example, the fabricator 150 affixes the bottom surface 761 of the substrate 720 to the top surface 161 of the transformer assembly 110. This may include soldering the axial ends of the electrically conductive paths 121 exposed on the surface 161 to corresponding surface mount pads disposed on a bottom surface 761 of the substrate 720. The substrate 720 provides connectivity as further discussed in FIG. 9.

The fabricator 150 affixes the top surface 762 of the substrate 710 to the bottom surface 162 of the transformer assembly 110. This may include soldering the axial ends of the electrically conductive paths 121 exposed on the surface 162 to corresponding pads on a top surface 762 of the substrate 710.

As previously discussed, the electrically conductive path 121-8 can be configured to convey the input voltage Vin from the substrate 710 through the electrically conductive path 121-8 of the transformer assembly 110 to the substrate 720, which supplies the input voltage Vin to the one or more switches Q11 and Q21.

As further shown in FIG. 9, the switches control flow of current through the windings to convert the input voltage Vin into the respective output voltage 123 (Vout). Accordingly, the switch circuitry (Q11, Q12, . . . ) controlled by the controller 140 supports conversion of the input voltage into the output voltage supplied through the electrically conductive paths 121-4 to the substrate 710.

FIG. 9 is an example diagram illustrating a power converter circuit implementing a transformer assembly to convert an input voltage into an output voltage as discussed herein.

In this example, the transformer assembly 110 is implemented in a respective power converter 900. As previously discussed, the transformer assembly 110 includes stack of windings 141 such as including winding W1, transformer winding W2, transformer winding W3, and transformer winding W4.

The power converter 900 further includes switch Q11, switch Q12, switch Q13, switch Q14, switch Q21, switch Q22, switch Q23, and switch Q24. Each of the switches may be a field effect transistor or other suitable type of switch.

Node D of a respective switch represents a drain node; node G represents a gate node; and node S represents a source node.

The power converter 900 further includes controller 140 as well as the capacitors C1, C2, and C3.

The controller 140 generates the control signal S1 that controls operation of the switches Q11, Q12, Q13, and Q14.

The controller generates the control signal S2 that controls operation of the switches Q21, Q22, Q23, and Q24.

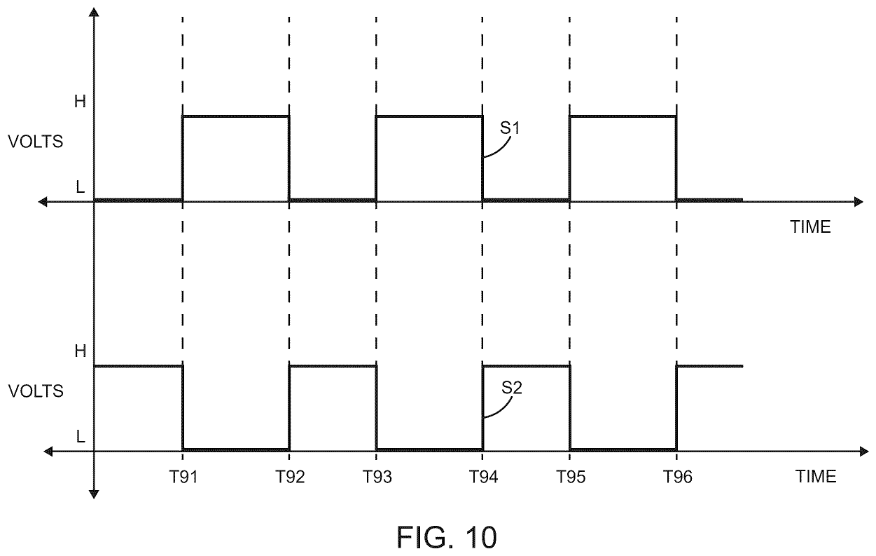

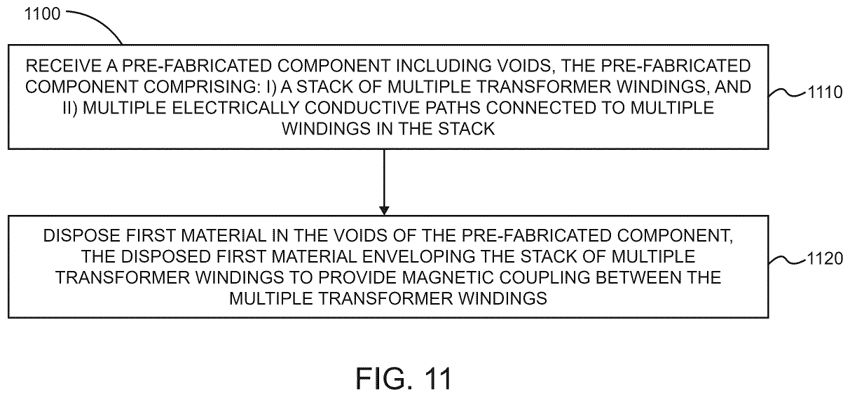

An example timing diagram of producing the control signals S1 and S2 is shown in FIG. 10. The controller 140 transmits the control signal S1 through the electrically conductive path 121-5 to the switches Q11, Q12, Q13, and Q14. The controller transmits the control signal S 2 through the electrically conductive path 121-3 to the switches Q21, Q22, Q23, and Q24.

Referring again to FIG. 9, the combination of switch Q11, capacitor C1, and switch Q22 are connected in series between the electrically conductive path 121-8 and the electrically conductive path 121-9. The winding W1 is connected between the electrically conductive path 121-6 and the electrically conductive path 121-4.

The combination of switch Q21, capacitor C2, and switch Q22 are connected in series between the electrically conductive path 121-8 and the electrically conductive path 121-9. The winding W2 is connected between the electrically conductive path 121-2 and the electrically conductive path 121-4.

The combination of switch Q11, switch Q23, and the switch Q14 are connected in series between the electrically conductive path 121-8 and the electrically conductive path 121-9. The winding W3 is connected between the electrically conductive path 121-1 and the electrically conductive path 121-4.

The combination of switch Q21, switch Q13 and the switch Q24 are connected in series between the electrically conductive path 121-8 and the electrically conductive path 121-9. The winding W4 is connected between the electrically conductive path 121-7 and the electrically conductive path 121-4.

The input voltage Vin supplied to the electrically conductive path 121-8 may be a DC voltage. Switching of the switches in the power converter 900 converts the input voltage Vin to the output voltage 123 (Vout) outputted from the electrically conductive path 121-4 to the load 118.

As previously discussed, the interconnectivity provided by the multiple electrically conductive paths 121 may result in the transformer assembly 110 be configured as an autotransformer.

Accordingly, in one example, the main characteristics of the implementation of the transformer assembly 110 are as follows:
The (auto)transformer (such as Stack 141 in the assembly 110) may be implemented as a monolithic block that comprises the windings and ferromagnetic core. On the sides of the ferromagnetic core, conductive pins (such as electrically conductive paths 121) are embedded (press-fitted, glued or fixed with some other method) and are grinded-down (or designed) to exactly match the core height. This is why this block may be considered a Transformer with embedded vertical pins (electrically conductive paths 121) for double-substrate modules. In short, TX.
The TX (a.k.a., transformer assembly 110) is the mechanical support for the TOP PCB (a.k.a., surface 162).
The TX windings can be configured to connect on the TOP PCB, they do not need to cross between TOP PCB and BOTTOM PCB (a.k.a., surface 161).
The TX implements some or all the electrical connections between TOP PCB and BOTTOM PCB.
TOP PCB and BOTTOM PCB have a footprint where TX is soldered in a reflow process.

When compared to conventional assemblies, the transformer assembly 110 as discussed herein provides the following advantages:
The TOP PCB has now much more space for the power FETs, which are desired to be connected to a heatsink.
The TOP PCB does not require any copper to implement the transformer (transform assembly 110), which is now build as a monolithic, standalone component. This provides additional space for paralleling FETs and other power connections.
Previously, the single block pins of a conventional assembly had to be precisely machined, especially in height, to avoid any “rocking” effect of the TOP PCB due to uneven height. This is now solved as the pins in the transformer simile 110 may be grinded-down together with the TX.
Previously, the single block pins of a conventional assembly required a precise positioning on the soldermask opening and could potentially move during the reflow, due to the very asymmetric form factor of the pins (very tall but with a tiny footprint). This also relieves the pick-and-place process complexity. Now, placing the TX can be performed in a single pick-and-place and the precision can be relaxed.

In general, the complexity of the planar transformer and the block pins is now moved altogether to the monolithic TX (110). This component (110) can be manufactured now independently of the substrates and tested on its own.

FIG. 10 is an example timing diagram illustrating control states of the multiple switches in the power converter circuit of FIG. 9 as discussed herein.

In this example, the controller 140 produces the control signal S1 at approximately a 50 percent (or less) duty cycle to drive multiple switches including switch Q11, switch Q12, switch Q13, and switch Q14.

For example, between time T91 and time T92, the controller 140 produces the control signal S1 to be a logic high resulting in activation of the switches including switch Q11, switch Q12, switch Q13, and switch Q14, to an ON-state; between time T93 and time T94, the controller 140 produces the control signal S1 to be a logic high resulting in activation of the switches including switch Q11, switch Q12, switch Q13, and switch Q14, to an ON-state; between time T95 and time T96, the controller 140 produces the control signal S1 to be a logic high resulting in activation of the switches including switch Q11, switch Q12, switch Q13, and switch Q14, to an ON-state; and so on.

Between time T92 and time T93, the controller 140 produces the control signal S1 to be a logic low resulting in deactivation of the switches including switch Q11, switch Q12, switch Q13, and switch Q14, to an OFF-state (a.k.a., short circuit path); between time T94 and time T95, the controller 140 produces the control signal S2 to be a logic low resulting in deactivation of the switches including switch Q21, switch Q22, switch Q23, and switch Q24, to an OFF-state; and so on.

Further, the controller 140 produces the control signal S2 at approximately a 50 percent (or less) duty cycle to drive multiple switches including switch Q21, switch Q22, switch Q23, and switch Q24.

For example, between time T91 and time T92, the controller 140 produces the control signal S2 to be a logic low resulting in deactivation of the switches including switch Q21, switch Q22, switch Q23, and switch Q24, to an OFF-state; between time T93 and time T94, the controller 140 produces the control signal S2 to be a low high resulting in deactivation of the switches including switch Q21, switch Q22, switch Q23, and switch Q24, to an OFF-state; between time T95 and time T96, the controller 140 produces the control signal S2 to be a logic low resulting in deactivation of the switches including switch Q21, switch Q22, switch Q23, and switch Q24, to an OFF-state; and so on.

Between time T92 and time T93, the controller 140 produces the control signal S2 to be a logic high resulting in activation of the switches including switch Q21, switch Q22, switch Q23, and switch Q24, to an OFF-state; between time T94 and time T95, the controller 140 produces the control signal S2 to be a logic low resulting in deactivation of the switches including switch Q21, switch Q22, switch Q23, and switch Q24, to an OFF-state; and so on.

It is further noted that there is a so-called dead time between turning off the first set of switches and turning on the second set of switches and vice versa. For example, the falling edge of signal S1 is just prior to time T92 and the rising edge of the signal S2 is just after the time T92; the falling edge of signal S2 is just prior to time T93 and the rising edge of the signal S1 is just after the time T93; and so on. Any amount of dead time is suitable such that the ON-time of signal S1 and ON-time of signal S2 do not overlap.

The functionality supported by the different resources will now be discussed via flowchart in FIG. 10. Note that the operations in the flowcharts below can be executed in any suitable order.

FIG. 10 is a flowchart illustrating an example method as discussed herein. Note that there will be some overlap with respect to concepts as discussed above.

In processing operation 1010 of flowchart 1000, the fabricator 150 receives a pre-fabricated component including voids, the pre-fabricated component comprising: i) a stack of multiple transformer windings, and ii) multiple electrically conductive paths connected to the multiple windings in the stack.

In processing operation 1020, the fabricator 150 disposes (such as via injection or other suitable technique) first material in the voids of the pre-fabricated component. The first material envelops the stack of multiple transformer windings to provide magnetic coupling between the multiple transformer windings. Additionally, the first material provides structural support for a combination of the stack of multiple transformer windings in the multiple electrically conductive paths.

Note again that techniques herein are well suited for use in circuit assembly applications such as those providing power delivery to one or more loads. However, it should be noted that the disclosure of matter herein is not limited to use in such applications and that the techniques discussed herein are well suited for other applications as well.

While this invention has been particularly shown and described with references to preferred aspects thereof, it will be understood by those skilled in the art that various changes in form and details may be made therein without departing from the spirit and scope of the present application as defined by the appended claims. Such variations are intended to be covered by the scope of this present application. As such, the foregoing description in the present disclosure is not intended to be limiting. Rather, any limitations to the invention are presented in the following claims.

1. A transformer assembly comprising:
a pre-fabricated component comprising: i) a stack of multiple transformer windings, and ii) multiple electrically conductive paths connected to the multiple transformer windings in the stack; and
first material disposed in voids of the pre-fabricated component, the first material enveloping the stack of multiple transformer windings to provide magnetic coupling between the multiple transformer windings.

2. The transformer assembly as in claim 1, wherein the first material is injected into the voids of the pre-fabricated component subsequent to directly coupling the multiple electrically conductive paths to the multiple transformer windings in the stack.

3. The transformer assembly as in claim 2, wherein the first material injected into the voids of the pre-fabricated component includes magnetically permeable material; and
wherein the first material provides structural support retaining the stack of multiple transformer windings in the multiple electrically conductive path.

4. The transformer assembly as in claim 2 further comprising:
second material at least partially enveloping the injected first material.

5. The transformer assembly as in claim 1, wherein the first material is injected into the voids of the pre-fabricated component, the injected first material being a monolithic mass of magnetically permeable material structurally supporting physical connection of the electrically conductive paths to the multiple transformer windings.

6. The transformer assembly as in claim 1, wherein the multiple electrically conductive paths are at least partially embedded in the first material.

7. The transformer assembly as in claim 6 further comprising:
at least one peripheral surface; and
wherein at least a portion of the multiple electrically conductive paths are disposed on the at least one peripheral surface.

8. The transformer assembly as in claim 1 further comprising:
a top surface;
a bottom surface;
wherein the first electrically conductive path of the multiple electrically conductive paths extends to the top surface; and
wherein the second electrically conductive path of the multiple electrically conductive paths extends to the bottom surface.

9. The transformer assembly as in claim 8, wherein the first electrically conductive path extends axially from the bottom surface to the top surface; and
wherein the second electrically conductive path extends axially from the bottom surface to the top surface, the second electrically conductive path being disposed in parallel with the first electrically conductive path.

10. The transformer assembly as in claim 1 further comprising:
a top surface;
a bottom surface;
a first surface mount footprint disposed on the top surface;
a second surface mount footprint disposed on the bottom surface;
wherein a pattern of the first surface mount footprint is substantially similar to a pattern of the second surface mount footprint.

11. The transformer assembly as in claim 1 further comprising:
first side surface disposed between a top surface and a bottom surface of the transformer assembly;
wherein the multiple electrically conductive paths are at least partially embedded in the first material enveloping the pre-fabricated component; and
wherein a first electrically conductive path of the multiple electrically conductive paths is exposed on the first side surface.

12. The transformer assembly as in claim 11, wherein the first electrically conductive path extends on the first side surface between the top surface of the transformer assembly and the bottom surface of the transformer assembly.

13. The transformer assembly as in claim 1, wherein interconnectivity provided by the multiple electrically conductive paths configures the stack of multiple transformer windings to be an autotransformer.

14. The transformer assembly as in claim 1, wherein the multiple transformer windings in the stack include: a first transformer winding fabricated in a first plane and a second transformer winding fabricated in a second plane, the first plane parallel with respect to the second plane; and
wherein the multiple electrically conductive paths extend orthogonally in the transformer assembly with respect to the first plane and the second plane.

15. The transformer assembly as in claim 14, wherein the pre-fabricating complement includes:
a first layer of insulation material separating the first transformer winding and the second transformer winding.

16. The transformer assembly as in claim 1, wherein the first material disposed in the voids includes ferromagnetic material operative to convey magnetic flux associated with the multiple transformer windings.

17. A circuit assembly comprising:
the transformer assembly as in claim 1, the transformer assembly including a top surface and a bottom surface;
a first circuit substrate affixed to the top surface of the transformer assembly; and
a second circuit substrate affixed to the bottom surface of the transformer assembly.

18. The circuit assembly as in claim 17 further comprising:
a first electrically conductive path extending from the second circuit substrate to the first circuit substrate, the first electrically conductive path operative to convey an input voltage through the first electrically conductive path to the first circuit substrate; and
a second electrically conductive path extending from the top surface of the transformer assembly to a first winding of the multiple windings.

19. The circuit assembly as in claim 18 further comprising:
switch circuitry disposed on the first circuit substrate, the switch circuitry operative to control conveyance of current received from the input voltage through the second electrically conductive path to the first winding.

20. A method of fabricating a transformer assembly, the method comprising:
receiving a pre-fabricated component including voids, the pre-fabricated component comprising: i) a stack of multiple transformer windings, and ii) multiple electrically conductive paths connected to the multiple transformer windings in the stack; and
disposing first material in the voids of the pre-fabricated component, the disposed first material enveloping the stack of multiple transformer windings to provide magnetic coupling between the multiple transformer windings.
